(19) United States
(12) Patent Application Publication
(10) Pub. No.: US 2023/0363588 A1
(43) Pub. Date: Nov. 16, 2023

(54) VACUUM PROCESSOR

(71) Applicant: Yuhua WANG, Beijing (CN)

(72) Inventor: Yuhua WANG, Beijing (CN)

(21) Appl. No.: 18/024,369

(22) PCT Filed: Aug. 27, 2021
(86) PCT No.: PCT/CN2021/114916

§ 371 Date: Mar. 2, 2023

(30) Foreign Application Priority Data
Sep. 4, 2020 (CN) 202021915687.9

(51) Int. Cl. A47J 43/046; A47J 43/07

(52) U.S. Cl. CPC A47J 43/046; A47J 43/0761; A47J 37/085

(57) ABSTRACT

The present disclosure provides a vacuum food processor, comprising: a base, a vacuum blender jar, and a lid assembly. A vacuum air extraction device is disposed inside the base; and the lid assembly comprises a lid body, a main sealing ring, a vacuum status indicator, a first vacuum air extraction channel, a second vacuum air extraction channel, and a pressure relief device, wherein the vacuum status indicator comprises a deformable deforming portion, such that under the action of atmospheric pressure, the vacuum status indicator is compressively deformed toward an inner cavity of the vacuum blender jar.

### CROSS-REFERENCE TO RELATED APPLICATIONS

The international application claims a priority of Chinese Utility Model Patent Application No. 202021915687.9 filed on Sep. 4, 2020, which is incorporated herein in its entirety by reference.

### TECHNICAL FIELD

The present disclosure relates to a technical field of processors, in particular to a vacuum blender.

### BACKGROUND ART

With increasing improvement of people's living standards, many household processors of different types have arisen in the market. Among them, there is a vacuum blender which can stir and process food after vacuum pumping to keep food materials fresh and prevent oxidation of the food materials. The existing vacuum blenders are generally problematical in failure to intuitively observe whether vacuum pumping in a cup body of the stirring cup has been finished and inconvenient pressure relief operation after the stirring is completed and before the cup cover is opened.

### SUMMARY

In order to solve deficiencies in the prior art, the present disclosure provides a vacuum blender which can intuitively observe whether vacuum pumping has been finished and conveniently perform a pressure relief operation.

The technical solutions adopted reside in:

The present disclosure provides a vacuum blender comprising a base, a vacuum stirring cup and a cup cover assembly, a vacuum pumping device being provided in the base, and the cup cover assembly comprising a cup cover main body, a main seal ring, a vacuum state indicator, a first vacuum pumping passage, a second vacuum pumping passage and a pressure relief device, wherein the vacuum state indicator includes a deformable part so that the vacuum state indicator is compressively deformable toward an inner cavity of the vacuum stirring cup under an atmospheric pressure.

In the vacuum blender of the present disclosure, a feeding port is opened in the cup cover main body, the cup cover assembly further includes a feeding cup, the feeding cup is detachably snap-fitted upside down in the feeding port, and the vacuum state indicator is mounted at a bottom of the feeding cup.

In the vacuum blender of the present disclosure, a slip hole is provided at the bottom of the feeding cup, an airtight seal is formed between the slip hole of the feeding cup and the vacuum state indicator, and the vacuum state indicator is movable within the slide hole toward or away from the inner cavity of the vacuum stirring cup relative to the bottom of the feeding cup.

In the vacuum blender of the present disclosure, the pressure relief device includes a first pressure relief air inlet, a second pressure relief air inlet, a sealing member, a pressure relief lever and a pressure relief button, both ends of the pressure relief lever are respectively connected to the pressure relief button and the sealing member, the pressure relief device further includes an elastic piece for automatically resetting the pressure relief lever, and the elastic piece is mounted on at least one end of the pressure relief lever.

In the vacuum blender of the present disclosure, a handle is provided outside a cup body of the vacuum stirring cup, and the second vacuum pumping passage is provided in the handle and passes through the handle longitudinally.

In the vacuum blender of the present disclosure, the first vacuum pumping passage is provided in the cup cover main body and passes through at least a portion of the cup cover main body, one end of the first vacuum pumping passage is connected to the inner cavity of the vacuum stirring cup, and the other end of the first vacuum pumping passage is connected to the vacuum pumping device through the second vacuum pumping passage.

In the vacuum blender of the present disclosure, a filter for preventing foreign matters from being sucked into the vacuum pumping device is provided in the first vacuum pumping passage.

In the vacuum blender of the present disclosure, the vacuum state indicator is formed with scale lines indicating a current pressure magnitude in a cup body of the vacuum stirring cup.

In the vacuum blender of the present disclosure, the vacuum state indicator is provided with a limiter, and the limiter is integrated with the deformable part to prevent the vacuum state indicator from being damaged due to excessive compression toward the inner cavity of the vacuum stirring cup under the atmospheric pressure in vacuum pumping.

In the vacuum blender of the present disclosure, the limiter has a limiter protrusion extending outward, a blocking groove is provided on an outer edge of the slip hole, and the blocking groove has a shape complementary to that of the limiter protrusion.

In the vacuum blender of the present disclosure, the cup cover assembly further includes a cover plate, and an accommodation chamber for accommodating the pressure relief device is formed between the cover plate and the cup cover main body.

In the vacuum blender of the present disclosure, a stirring motor is provided in the base, a stirring cutter is provided in the vacuum stirring cup, and an output shaft of the stirring motor is detachably connectable to a rotation shaft of the stirring cutter.

In the vacuum blender of the present disclosure, the deformable part is made of a silicagel material.

After the above technical solutions are adopted, the vacuum blender provided by the present disclosure has the following advantages:
1. During vacuum pumping of the stirring cup by the vacuum pumping device, a user can clearly observe whether the vacuum pumping has been finished through telescopic movement of the vacuum state indicator relative to the cup cover;
2. When the cup cover is required to be opened after food processing is completed, due to a pressure difference between a vacuum pressure inside a cup body of the stirring cup and an atmospheric pressure outside the cup body of the stirring cup, the cup cover can not be opened until the pressure relief is completed. The pressure relief lever is driven by pressing the pressure relief button to lift up a sealing member, external air then enters the vacuum stirring cup through the pressure relief air inlet, and a pressure relief operation can be conveniently completed after a pressure balance is achieved.

### BRIEF DESCRIPTION OF THE DRAWINGS

FIG. 1 is an overall perspective view of a vacuum blender of the present disclosure.

FIG. 2 is an exploded schematic diagram of constituent parts of the vacuum blender of the present disclosure.

FIG. 3 is a perspective view of a cup cover assembly of the vacuum blender of the present disclosure.

FIG. 4 is a top view of the cup cover assembly of the vacuum blender of the present disclosure.

FIG. 5 is a side cross-sectional view of a vacuum state indicator taken along a line A-A in FIG. 4 of the vacuum blender of the present disclosure.

FIG. 6 is a side cross-sectional view of a pressure relief device taken along a line D-D in FIG. 4 of the vacuum blender of the present disclosure.

FIG. 7 is a bottom view of the cup cover assembly of the vacuum blender of the present disclosure.

Reference signs in the drawings have the following meanings:
1—vacuum blender; 2—base; 3—vacuum stirring cup; 4—cup cover assembly; 21—vacuum pumping device; 22—stirring motor; 31—stirring cutter; 32—handle; 33—second vacuum pumping passage; 41—cup cover main body; 411—cup cover extension; 42—main seal ring; 43—vacuum state indicator; 431—limiter; 4311—limiter protrusion; 432—deformable part; 44—first vacuum pumping passage; 441—filter; 442—first air extraction port; 443—second air extraction port; 45—pressure relief device; 451—second pressure relief air inlet; 452—sealing member; 453—pressure relief lever; 454—pressure relief button; 455—first pressure relief air inlet; 456—sealing member; 457—first elastic piece; 458—second elastic piece; 46—feeding port; 47—feeding cup; 471—feeding cup seal ring; 472—slip hole; 473—blocking groove; 474—fixing member; 48—cover plate; 49—accommodation chamber.

### DETAILED DESCRIPTION OF THE EMBODIMENTS

Embodiments of the present disclosure will be described in detail below with reference to accompanying drawings. In the description of the present disclosure, terms such as “upper”, “lower”, “left” and “right” indicating orientations are used to facilitate description of directions and positions in the technical solutions, but do not constitute a limitation to the embodiments.

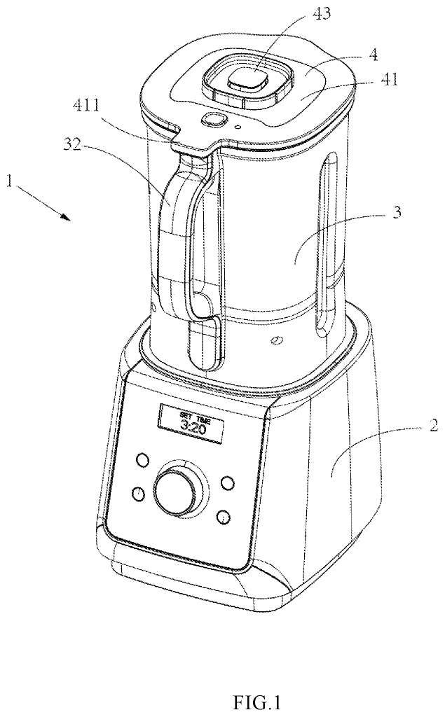

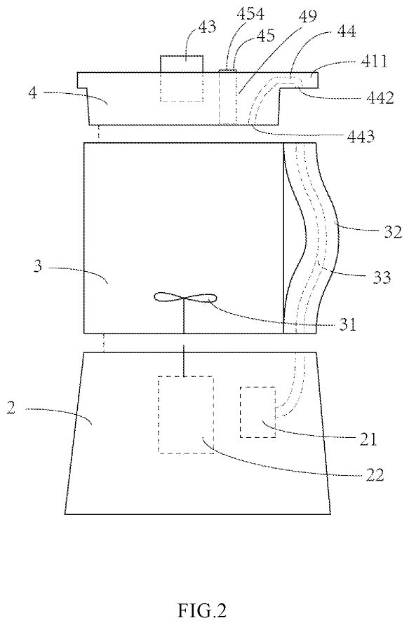

FIG. 1 is an overall perspective view of a vacuum blender of the present disclosure. FIG. 2 is an exploded schematic diagram of constituent parts of the vacuum blender of the present disclosure.

As shown in FIGS. 1, 2 and 5, the present disclosure provides a vacuum blender 1, the vacuum blender 1 comprises a base 2, a vacuum stirring cup 3 and a cup cover assembly 4 which are snap-fitted sequentially, and a vacuum pumping device 21 is provided in the base 2. The cup cover assembly 4 includes a cup cover main body 41, a main seal ring 42, a vacuum state indicator 43, a first vacuum pumping passage 44, a second vacuum pumping passage 33 and a pressure relief device 45. The vacuum state indicator 43 includes a deformable part 432 so that the vacuum state indicator 43 is compressively deformable toward an inner cavity of the vacuum stirring cup 3 under an atmospheric pressure.

As shown in FIG. 2, a handle 32 is provided outside a cup body of the vacuum stirring cup 3, and the second vacuum pumping passage 33 is provided inside the handle 32 and passes through the handle 32 longitudinally. The cup cover main body 41 also includes a cup cover extension 411 extending outward, and the first vacuum pumping passage 44 is provided in the cup cover main body 41 and passes through at least a portion (the cup cover extension 411) of the cup cover main body 41. A first air extraction port 442 and a second air extraction port 443 are provided on both ends of the first vacuum pumping passage 44 respectively. The first air extraction port 442 is located in the cup cover extension 411, and the second air extraction port 443 leads to the inner cavity of the vacuum stirring cup 3. When the cup cover assembly 4 is in snap-fit with the vacuum stirring cup 3, the vacuum pumping passage 44 is airtightly connected to the second vacuum pumping passage 33 in the handle 32 through the first air extraction port 442 and finally connected to the vacuum pumping device 21 in the base 2.

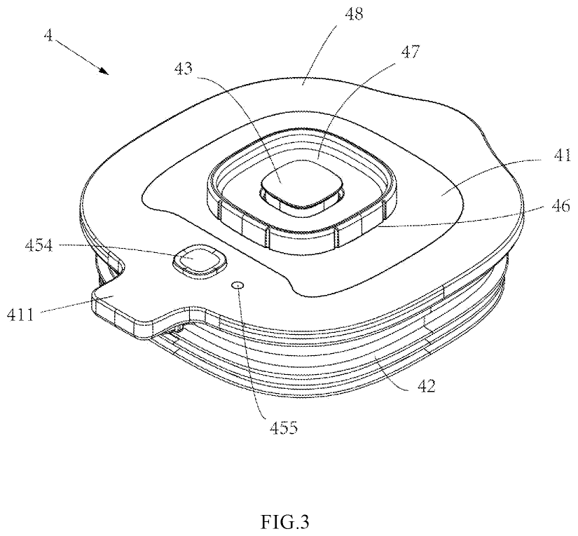

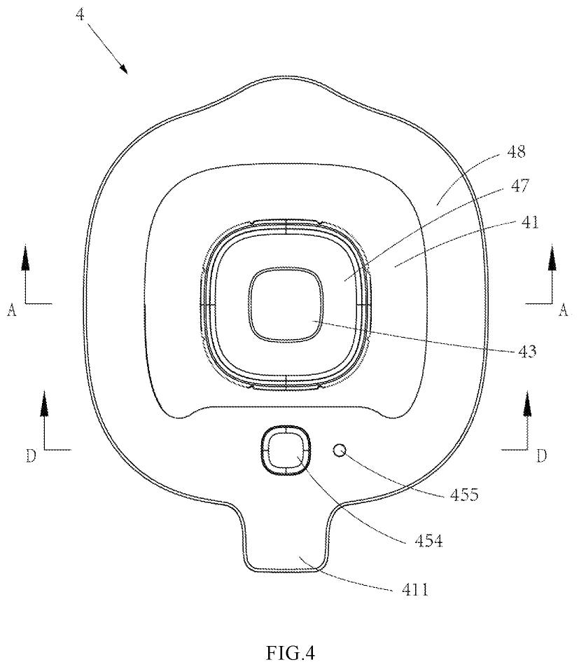

FIG. 3 and FIG. 4 are a perspective view and a top view of the cup cover assembly 4 respectively. When the cup cover assembly 4 is snap-fitted on the vacuum stirring cup 3, the main seal ring 42 of the cup cover assembly 4 is in airtight contact with an inner side wall of the vacuum stirring cup 3 to ensure that the air in the cup body of the vacuum stirring cup 3 is separated from external air, and it is convenient to exhaust the air in the cup body through the vacuum pumping device 21 to attain an object of preventing the food from being oxidized during stirring and processing.

A feeding port 46 is provided in the cup cover main body 41, the cup cover assembly 4 also includes a feeding cup 47 which is detachably snap-fitted upside down in the feeding port 46 with a bottom facing upward and an opening facing downward, and the vacuum state indicator 43 is mounted at a bottom of the feeding cup 47. During food processing, if food materials are required to be added into the vacuum stirring cup 3 midway, the feeding port 46 can be opened only by removing the feeding cup 47, and thus food materials can be put from the feeding port 46 without taking off the entire cup cover assembly 4.

FIG. 5 is a local enlarged view of the cross-sectional view taken along a direction A-A in FIG. 4. As shown in FIG. 5, the cup cover main body 41 is provided with the charging port 46, and the feeding cup 47 is mounted in the feeding port 46 in an inverted manner. In order to guarantee air tightness, a feeding cup seal ring 471 is further provided on the feeding cup 47 so that the external air is isolated from the air in the vacuum stirring cup 3 when the feeding cup 47 is placed into the feeding port 46, and the vacuum state indicator 43 is provided at the bottom of the feeding cup 47.

As shown in FIG. 5, the bottom of the feeding cup 47 includes a vertical slip hole 472, an airtight seal is formed between the slip hole 472 of the feeding cup 47 and the vacuum state indicator 43, and the vacuum state indicator 43 is movable within the slip hole 472 toward or away from the inner cavity of the vacuum stirring cup 3 relative to the bottom of the feeding cup 47.

As mentioned above, the vacuum state indicator 43 includes the deformable part 432, and the deformable part 432 is made of a soft elastic material such as silica gel. The vacuum state indicator 43 will be compressively deformed toward the inner cavity of the vacuum stirring cup 3 under the atmospheric pressure. The lower the air pressure in the stirring cup 3 is and the higher the atmospheric pressure acting on the vacuum state indicator 43 is, the greater the degree of compressive deformation of the vacuum state indicator 43 toward the inner cavity of the vacuum stirring cup 3 becomes.

In order to prevent the vacuum state indicator 43 from being damaged due to excessive compressive deformation toward the inner cavity of the vacuum stirring cup 3 under the atmospheric pressure during vacuum pumping, the vacuum state indicator 43 also includes a limiter 431 which is rigid and integrated with at least a portion (a central portion) of the deformable part 432 (e.g., by means of an adhesive), and a circumferential edge portion of the deformable part 432 is fixed to a lower surface of the bottom of the feeding cup 47 with a fixing member 474. When compressively deformed, the deformable part 432 drives the limiter 431 to move within the slip hole 472 relative to the bottom of the feeding cup 47. A user can clearly know whether the current vacuum pumping procedure has been finished by observing a compressed state of the vacuum state indicator 43 (the deformable part 432). An exposed outer side wall of the vacuum state indicator 43 is also formed with scale lines (not shown) which indicates a relative position of the vacuum state indicator 43 relative to the bottom of the feeding cup 47 and indicates a magnitude of the pressure in the vacuum stirring cup 3, and the vacuum pumping procedure can be intuitively observed through the scale lines, which improves experience of the user.

As shown in FIG. 5, the limiter 431 has a limiter protrusion 4311 extending outward (along a left-right direction in FIG. 5), a blocking groove 473 is provided on an outer edge (an upper edge in FIG. 5) of the slip hole 472, and the blocking groove 473 has a shape complementary to that of the limiter protrusion 4311. When the limiter 431 moves down to a position at which the limiter protrusion 4311 is engaged with the blocking groove 473, the limiter 431 is blocked by the slip hole 472 and can not move further, thereby preventing the vacuum state indicator 43 from being damaged due to excessive compressive deformation toward the inner cavity of the vacuum stirring cup 3 under the atmospheric pressure.

It is a matter of course that the vacuum state indicator 43 is not limited to be provided at the bottom of the feeding cup 47, but can also be provided at other positions on the cup cover main body 41.

In the foregoing, an object to be processed by the vacuum blender 1 is food. The present disclosure is not limited thereto, and any item that is required to be stirred and processed and needs to be prevented from being oxidized can be used as the object to be processed by the vacuum blender 1.

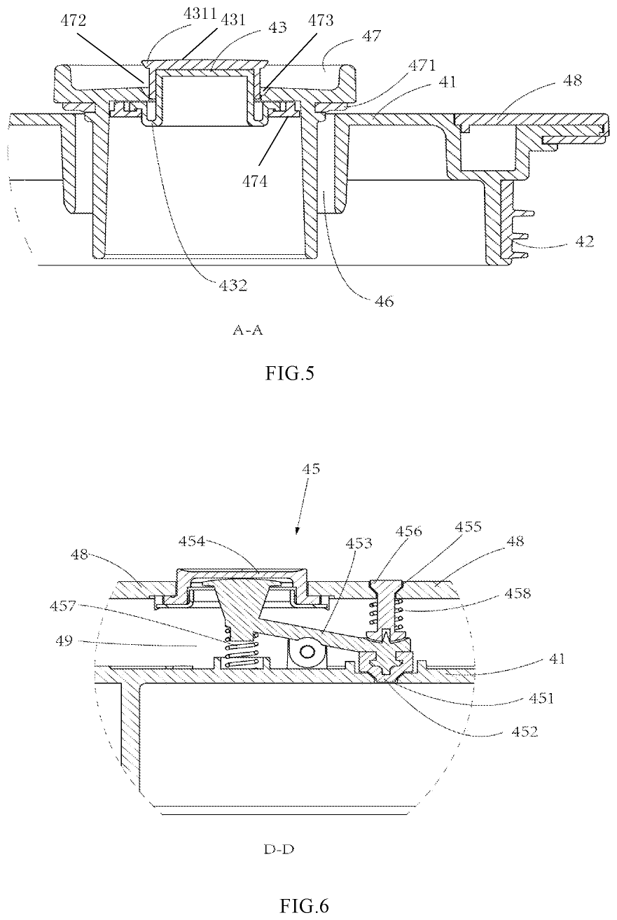

FIG. 6 is a local enlarged view of a cross-sectional view taken along a direction D-D in FIG. 4, showing a specific structure of the pressure relief device 45. As shown in FIG. 6, the cup cover assembly 4 further includes a cover plate 48, and an accommodating chamber 49 for accommodating the pressure relief device 45 is formed between the cover plate 48 and the cup cover main body 41.

The pressure relief device 45 includes a first pressure relief air inlet 455, a second pressure relief air inlet 451, a sealing member 452, a pressure relief lever 453, a pressure relief button 454, a sealing member 456, a first elastic piece 457 and a second elastic piece 458, the second pressure relief air inlet 451 is opened in the cup cover main body 41, and the first pressure relief air inlet 455 is opened in the cover plate 48. The pressure relief lever 453 is hinged on the cup cover main body 41 at a fulcrum, and both ends of the pressure relief lever 453 are respectively connected to the pressure relief button 454 and the sealing member 452. That is, the pressure relief button 454 is provided on one end of the pressure relief lever 453, and the sealing member 452 is mounted on the other end of the pressure relief lever 453 in sealed contact with the second pressure relief air inlet 451. For example, the first elastic piece 457 and the second elastic piece 458 may be compressible springs.

Although it is shown in FIG. 6 that one elastic piece (two elastic pieces in total) is provided on each end of the pressure relief lever 453, only one elastic piece may be provided on either end of the pressure relief lever 453.

The pressure relief device 45 has two states including a sealed state and a pressure relief state (the sealed state is shown in FIG. 6). When the pressure relief device 45 is in the sealed state, the sealing member 452 is in tight contact with the second pressure relief air inlet 451 under a pressure exerted via leverage by the first elastic piece 457 so that air can not pass through the second pressure relief air inlet 451, which is convenient for vacuum pumping. Meanwhile, moisture is also prevented from entering the accommodation chamber 49 during cleaning of the cup cover assembly 4 after use. Similarly, the sealing member 456 is in sealed contact with the first pressure relief air inlet 455 under the action of the second elastic piece 458 so that the external air can not enter the accommodation chamber 49, and moisture can be prevented from entering the accommodation chamber 49 through the first pressure relief air inlet 455 during cleaning.

When the cup cover assembly 4 is required to be opened after the food processing is completed, the cup cover assembly 4 can not be opened due to a pressure difference between the vacuum pressure inside the vacuum stirring cup 3 and the atmospheric pressure outside the cup body of the vacuum stirring cup 3. The external air is required to flow into the vacuum stirring cup 3, and the cup cover assembly 4 can only be opened till after an internal and external air pressure balance is achieved. At this time, it is necessary to bring the pressure relief device 45 into the pressure relief state. When the pressure relief button 454 is pressed, the sealing member 452 is lifted up by the pressure relief lever 453 to open the second pressure relief air inlet 451 and the sealing member 456 is lifted up simultaneously to open the first pressure relief air inlet 455 so that the external air quickly enters the accommodation chamber 49 through the first pressure relief air inlet 455 under the atmospheric pressure and then enters into the vacuum stirring cup 3 through the second pressure relief air inlet 451, and thus the pressure relief procedure can be completed. When the pressure relief procedure is completed, the pressure relief button 454 is loosened, and the pressure relief device 45 is then restored into the sealed state under the action of the first elastic piece 457 and the second elastic piece 458.

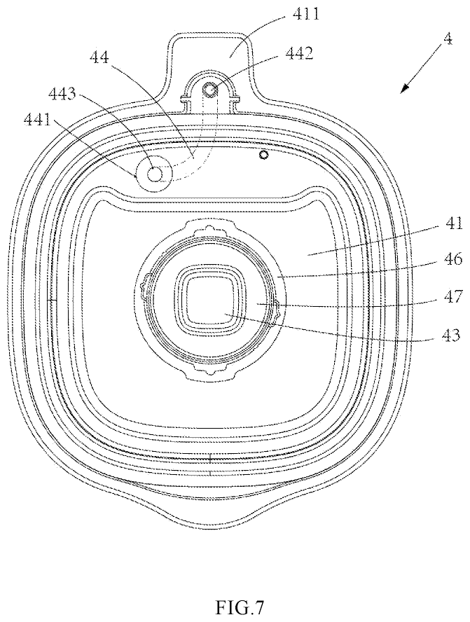

FIG. 7 is a bottom view of the cup cover assembly 4. As seen from FIG. 7, the first air extraction port 442 of the first vacuum pumping passage 44 is located in the cup cover extension 411, and the second air extraction port 443 leads to the inner cavity of the vacuum stirring cup 3. In order to prevent foreign matters such as food particles from being sucked into the vacuum pumping device 21 through the second air extraction port 443 to damage the vacuum pumping device 21, a filter 441 is provided at the second air extraction port 443.

As shown in FIG. 2, a stirring motor 22 is provided in the base 2, a stirring cutter 31 is provided in the vacuum stirring cup 3, and an output shaft of the stirring motor 22 is detachably connected to a rotation shaft of the stirring cutter 31. The vacuum stirring cup 3 is detachably mounted on the base 2, and when the vacuum stirring cup 3 is mounted on the base 2, the stirring cutter 31 obtains power from the stirring motor 22 to process food or other items.

The vacuum blender of the present disclosure can intuitively observe whether the vacuum pumping has been finished and conveniently perform the pressure relief operation. It is to be understood that the vacuum state indicator of the present disclosure is not limited to the specific form in the embodiments, and it belongs to a solution equivalent to the inventive concept of the present disclosure as long as a visual or sensible indication can be represented with the compressive deformation or positional movement during a pressure reduction procedure of the vacuum pumping.

Main features, technical principles and advantages of the present disclosure have been described above in connection with the embodiments. The above embodiments are not intended to limit the present disclosure, and any modifications, equivalent replacements and improvements made to the present disclosure without departing from the sprit or tenet of the present disclosure should fall within the protection scope of the present disclosure.

1. A vacuum blender comprising a base, a vacuum stirring cup and a cup cover assembly, a vacuum pumping device being provided in the base, and the cup cover assembly comprising a cup cover main body, a main seal ring, a vacuum state indicator, a first vacuum pumping passage, a second vacuum pumping passage and a pressure relief device, wherein the vacuum state indicator includes a deformable part so that the vacuum state indicator is compressively deformable toward an inner cavity of the vacuum stirring cup under an atmospheric pressure.

2. The vacuum blender according to claim 1, wherein a feeding port is opened in the cup cover main body, the cup cover assembly further includes a feeding cup, the feeding cup is detachably snap-fitted upside down in the feeding port, and the vacuum state indicator is mounted at a bottom of the feeding cup.

3. The vacuum blender according to claim 2, wherein a slip hole is provided at the bottom of the feeding cup, an airtight seal is formed between the slip hole of the feeding cup and the vacuum state indicator, and the vacuum state indicator is movable within the slide hole toward or away from the inner cavity of the vacuum stirring cup relative to the bottom of the feeding cup.

4. The vacuum blender according to claim 1, wherein the pressure relief device includes a first pressure relief air inlet, a second pressure relief air inlet, a sealing member, a pressure relief lever and a pressure relief button, both ends of the pressure relief lever are respectively connected to the pressure relief button and the sealing member, the pressure relief device further includes an elastic piece for automatically resetting the pressure relief lever, and the elastic piece is mounted on at least one end of the pressure relief lever.

5. The vacuum blender according to claim 1, wherein a handle is provided outside a cup body of the vacuum stirring cup, and the second vacuum pumping passage is provided in the handle and passes through the handle longitudinally.

6. The vacuum blender according to claim 5, wherein the first vacuum pumping passage is provided in the cup cover main body and passes through at least a portion of the cup cover main body, one end of the first vacuum pumping passage is connected to the inner cavity of the vacuum stirring cup, and the other end of the first vacuum pumping passage is connected to the vacuum pumping device through the second vacuum pumping passage.

7. The vacuum blender according to claim 1, wherein a filter for preventing foreign matters from being sucked into the vacuum pumping device is provided in the first vacuum pumping passage.

8. The vacuum blender according to claim 1, wherein the vacuum state indicator is formed with scale lines indicating a current pressure magnitude in a cup body of the vacuum stirring cup.

9. The vacuum blender according to claim 3, wherein the vacuum state indicator is provided with a limiter, and the limiter is integrated with the deformable part to prevent the vacuum state indicator from being damaged due to excessive compression toward the inner cavity of the vacuum stirring cup under the atmospheric pressure in vacuum pumping.

10. The vacuum blender according to claim 9, wherein the limiter has a limiter protrusion extending outward, a blocking groove is provided on an outer edge of the slip hole, and the blocking groove has a shape complementary to that of the limiter protrusion.

11. The vacuum blender according to claim 1, wherein the cup cover assembly further includes a cover plate, and an accommodation chamber for accommodating the pressure relief device is formed between the cover plate and the cup cover main body.

12. The vacuum blender according to claim 1, wherein a stirring motor is provided in the base, a stirring cutter is provided in the vacuum stirring cup, and an output shaft of the stirring motor is detachably connectable to a rotation shaft of the stirring cutter.

13. The vacuum blender according to claim 1, wherein the deformable part is made of silicone gel or silicone rubber.
